(19) United States
(12) Patent Application Publication
(10) Pub. No.: US 2002/0059247 A1
(43) Pub. Date: May 16, 2002

(54) Method of and apparatus for registering and reproducing homeopathic information

(75) Inventors: Klaus Dillinger, St. Polten (AT); Christian Steiner, Viktring (AT)

Correspondence Address: THE FIRM OF KARL F ROSS, 5676 RIVERDALE AVENUE, PO BOX 900, RIVERDALE (BRONX), NY, 10471-0900, US

(73) Assignee: QUINTSYSTEME FUR HOLOPATHISCHE MEDIZIN GES.M.B.H.

(21) Appl. No.: 09/894,487

(22) Filed: Jun. 28, 2001

(30) Foreign Application Priority Data
Jul. 6, 2000 (AT) GM496/2000

(51) Int. Cl. G06F 17/30

(52) U.S. Cl. 707/10; 707/1

(57) ABSTRACT

Homeopathic information in the form of electromagnetic spectra or combinations of spectra or spectra sums are downloaded through a global communication network from a site to a terminal and are used to produce homeopathic medicaments or test substances or for treatment of the patient. The homeopathic data is stored and reproduced by music storage and communication formats, especially MP3.

### FIELD OF THE INVENTION

Our present invention relates to a method of registering and reproducing homeopathic information and to an apparatus for that purpose utilizing the digitalization of an analog electromagnetic spectrum and the recordal of the digitalized spectrum in an appropriate data storage medium, especially an electronic storage medium of a data processor.

The invention also relates to a method of reproducing homeopathic information in the form of electromagnetic oscillations whereby one or more spectra which can be substance-specific or body-specific in the homeopathic sense can be selected from a multiplicity of such spectra stored in a storage medium and downloaded to a data processor from which the spectra or a spectrum can be converted into an analog signal, amplified and applied, preferably by at least one electrode or antenna in a homeopathic sense. This application of electromagnetic oscillations in a homeopathic sense can be used for treatment or for the production of homeopathic medicaments and test substances.

The invention also relates to a device for reproducing homeopathic information in the form of such electromagnetic oscillations and which can include the storage medium, a digital to analog (D/A) converter and a device for-applying the electromagnetic oscillations.

### BACKGROUND OF THE INVENTION

By and large homeopathic preparations are prepared by dilution, mixing and like procedures some stocks available at sources of homeopathic preparations and usually stored in bottles or other packaging materials. One of the problems with earlier homeopathic treatments and the use of homeopathic medicaments is that conventional homeopathic preparations have only a limited storage time and maybe sensitive to an appropriate storage conditions such as a wrong temperature, the effect of a material or manmade electromagnetic field or to some other condition which can lead to a loss of effectiveness.

As a result, interest has been developed in systems for converting homeopathic information to homeopathic preparations or for the direct treatment of a patient utilizing homeopathic information.

Austrian Utility Model AT 130 U describes a method in which the energetic spectra of different substances can be registered and reproduced either on an analog or on a digital basis.

Austrian Utility Model AT 1358 U describes various methods and apparatus by means of which the homeopathic information, which can be available in a recorded form, can be applied to individuals or the environment.

U.S. Pat. No. 5,830,140 describes the storage of substance-specific and body-specific information in the form of electromagnetic signals after separation with bandpass filters and the use of the stored information to produce a homeopathic medicament with a carrier or to activate an alcohol water mixture.

In the Austrian utility models and U.S. patent, it is made clear that the effect of homeopathic medicaments may not primarily be of a biochemical nature, but rather is largely biophysical and based upon electromagnetic waves. It is therefore possible by means of appropriate devices to store homeopathic information digitally in a computer system, to reproduce that homeopathic information and to apply the reproduced homeopathic information to an appropriate individual or patient or to provide a medicament for homeopathically treating that individual.

The terms “homeopathic information” and “energetic information” are used in the present document to describe that substance-specific or body-specific information which corresponds to the long-wave portion of the oscillation spectrum and can be used for homeopathic treatment of the individual directly or the preparation of homeopathic medicaments or test substances. The use of such homeopathic information with electromagnetic storage or processing has considerable advantages for the diagnosis and treatment of disorders or pathologies since, by comparison with conventional preparation and use of homeopathic medicament and test substances, the homeopathic information can be stored for practically unlimited periods of time, can be used anywhere and at any time without loss of effectivity. A drawback of prior methods and apparatus however has been that these can be used or are available only in a limited number of institutions, clinics or treatment sites because the apparatus and the requisite data acquisition and storage can be relatively expensive. This is especially a problem since treatment times in homeopathic therapy tend to be prolonged and up to now the patient had to seek out an appropriate institute, hospital or clinic for the treatment or remain for the duration of the treatment. All of these resulted in substantial treatment costs.

### OBJECTS OF THE INVENTION

It is, therefore, the principal object of the present invention to provide a method and apparatus which eliminates these drawbacks and can make available the homeopathic information and treatments more economically and more efficiently than has hitherto been the case.

Another object of this invention is to provide a method of and an apparatus for homeopathic information storage, reproduction and use which allows medications and test substances to be prepared anywhere and at any time conveniently and which permits treatment of a patient with the homeopathic or energetic information practically anywhere and at any time as well.

### SUMMARY OF THE INVENTION

These objects and others which will become apparent hereinafter in a method of registering homeopathic information which comprises the steps of:

(a) obtaining an analog electromagnetic spectrum representing homeopathic information;

(b) digitizing the analog electromagnetic spectrum to produce a digitalized spectrum containing the homeopathic information; and

(c) storing the digitalized spectrum on a data-storage medium with a data processor in a digital music compression data format for digital communication and reproduction of music.

The invention also comprises a method of using homeopathic information which comprises the steps of:

(a) storing homeopathic information in a form of a plurality of electromagnetic homeopathic spectra at a site;

(b) accessing the site and selecting at least one of the stored plurality of homeopathic spectra with a global computer information network from a location other than the site;

(c) at the location with a data processor recording in a data storage medium a selected homeopathic spectrum through the global computer information network;

(d) converting the selected homeopathic spectrum recorded in the data storage medium to an analog signal; and

(e) amplifying and homeopathically applying the analog signal.

The latter method can involve storage of the electromagnetic spectra at the storage site by:

(a1) obtaining an analog electromagnetic spectrum representing homeopathic information for each of a number of medical symptoms and physiological indications;

(a2) digitizing each of the analog electromagnetic spectra to produce a respective digitalized spectrum containing the respective the homeopathic information; and

(a3) storing all of the digitalized spectra on a data-storage medium at the site in a digital music compression data format for digital communication and reproduction of music.

In apparatus terms, in the most general sense, the apparatus for reproducing homeopathic information in the form of electromagnetic oscillations can comprise:

a data processor having a data storage medium in which homeopathic information is stored as digitalized spectra on a data-storage medium in a digital music compression data format for digital communication and reproduction of music;

a digital-to-analog converter for converting a homeopathic spectrum recorded in the data storage medium to an analog signal; and

a device for amplifying and homeopathically applying the analog signal to output corresponding electromagnetic oscillations.

The apparatus for using the electromagnetic information can also comprise:

a data processor connectable by modem or wirelessly to a global computer information network for downloading digitally recorded electromagnetic spectra carrying homeopathic information;

a data storage for the data processor for registering a digitally recorded electromagnetic spectra carrying homeopathic information downloaded from the network;

a digital-to-analog converter for converting a homeopathic spectrum recorded in the data storage an analog signal; and

a device for amplifying and homeopathically applying the analog signal to output corresponding electromagnetic oscillations.

According to the invention, therefore, the method of registering body-specific or substance-specific energetic information involves digitalization of an analog electromagnetic spectrum, e.g. as obtained in the aforementioned U.S. Pat. No. 5,830,140, and storing the digitalized spectrum in an electronic storage medium. According to the present invention the digitalized spectrum is stored in a data format which is used in the communication and reproduction of music and preferably in the MP3-format. The MP3 format is the format developed by the Fraunhofer Institut fur Integrierte Schaltungen in Germany together with Thomson Electronics and often referred to as MPEG-1 Layer 3.

The use of these existing technical standards which have become conventional for the communication and reproduction of music for the registration of substance specific information required for homeopathic medicaments, allows processing of the spectra utilizing spectral analysis by data processing systems which have become conventional for the transmission and reproduction of music. As a result, these spectra can be transmitted via a global communication information network, especially the internet since any device which can be connected to the internet and can support the MP3 data format, for example, can be used for the process and reproduction of the homeopathic information. These devices include PC's, digital music reproduction devices, wireless mobile telephones and the like.

The MP3 format is widely used on the internet for the distribution of music and is practically supported by all terminals connected to the internet. It enables high quality storage and reproduction of the digital oscillation information while at the same time providing maximum compression. Both aspects are important for the use of the system to enable communication of homeopathic information from a website through the internet to a location or site of use. In fact, there are available small portable MP3 players on the market whereby the oscillation information can be readily reproduced.

In the method of reproducing homeopathic information in the form of electromagnetic oscillations according to the invention, one or more homeopathic spectra can be selected from an entire library of such spectra stored at a central website and based upon the need or desire at the downloading location. Upon downloading of the selected spectra or spectrum at this location by a data processor supporting the MP3 format and the storage of the downloaded spectrum or spectra in memory at this location, the downloaded spectra or spectrum can be converted into an analog signal, amplified and then applied to a device which utilizes the electromagnetic oscillations, preferably via at least one electrode or antenna. The selected spectrum or spectra from the internet site is thus capable of treating an individual or preparing specific medicaments or test solutions at the local site connected to the internet. Homeopathic information can thus be supplied by this process to any location connected to the internet and called up from any locality or terminal connected to the internet. Mobile diagnosis and therapy is possible and any required test substances and therapeutic materials can be effectively downloaded from the internet or prepared from the downloaded information.

Advantageously the selection of the spectra which are to be downloaded can be made based upon one or more symptoms of the patient or physiological indications which can be transmitted to the downloading or website. At the downloading or website symptom and physiological information can be recorded together with the spectrum or spectra.

The downloaded information may be a package of the spectra or spectrum and the information with respect to the symptoms and physiological indications (e.g. degree of debilitation, degree of stress, premenstrual syndromes, digestive disorders, headaches, chills, fever . . . ) can be delivered as a unit. The downloading can be effected by the click of the mouse to the terminal of the user. According to a feature of the invention, depending upon the selection made, the spectra themselves may be used or the sum of the spectra can be calculated and connected to the data processor.

According to the invention, every spectra or every spectrum sum can be associated with dose information which is recorded at the website and is provided (downloaded) when selected spectra or spectrum sum is downloaded. The dose information can include information as to the duration or treatments, the number of treatments and the time spacing between treatments. The data as to the dose information can be downloaded with the electromagnetic oscillations and preferably both the dose information and the particularly electromagnetic oscillation signals can be downloaded in response to the input of particular symptoms or physiological indications so that correct dosage data is given reliably in response to each inquiry to the website with respective symptom and physiological data. This permits a treatment with a particular medicament prepared from the downloaded electromagnetic oscillations with predetermined but variable time intervals and over a specified duration. The built in programming possibilities of MP3 devices can be utilized for the storage and reproduction of the dosage data and the selection of the MP3 record can then depend upon the particular physiological indication or symptoms so that, upon the selection of a particular record, the user will have all of the data with respect to the particular medicament or test substance which can be prepared from the downloaded spectrum or sum together with the use data.

Sequential therapy programs with a plurality of medicaments with various optional sequences can also be assembled at the downloading location or can be downloaded as previously prepared from the website or central location. The method can be used at the downloading site for the production of homeopathic medicaments and test substances or for direct treatment of the individual case. At the local terminal a carrier substance, e.g. a solution, a salve or ointment balm or globuli can be activated by electrodes inserted therein or brought proximal to the carrier substance or by bringing the carrier substance proximal to the antenna or by providing the carrier so close to the apparatus for playing back the MP3 information that the homeopathic information is conveyed to the carrier by the electromagnetic emanations representing the downloaded MP3 recording. The homeopathic information is thereby impressed on the carrier substance and a so-to-speak synthetic homeopathic substance is produced.

The apparatus for reproducing homeopathic information in the form of electromagnetic oscillations can include, as described, a storage or memory for the digital signals, a D/A or digital analog converter and a device for outputting electromagnetic oscillations which can comprise any kind of reproducing device for digital music and, of course, the electrode or electrodes and the antenna unless for outputting the electromagnetic signals. Such reproduction devices are presently or can be expected in the near future to be available in practically every household and can be in the form of a PC or even a portable MP3 player. The costs for such apparatus are significantly lower than the costs for apparatus described in the aforementioned utility models and United States patent. Such portable devices can also be made available on a rental basis in pharmacies or at other locations promoting homeopathic approaches to medicine. The devices for treating the person or the medicament can also be fabricated at comparatively low cost.

The latter devices, for example, can be connected to the analog outputs of conventional playback units for digitally recorded music. With the aid of such devices, which can be connected to the earphone jacks of the playback unit, efficient, user friendly and inexpensive applications of the transmitted homeopathic information is possible. Such a conventional playback device for digitally recorded music can be an MP3 player which is currently available as a small portable unit on the market. Preferably the device includes means for downloading data from the internet via a modem or in a wireless manner so that the spectra to be utilized ban be communicated to this device. For example, the reproducing device for digitally recorded music can be an internet-capable mobile wireless telephone that supports the data format for music reproduction. This can be connected directly to the internet, for example, in accordance with the WAP standard. The device can, therefore, be a portable unit carried by the individual to be treated himself or herself.

According to a particularly advantageous feature of the invention, the additional device for applying the homeopathic information can generate a weak electromagnetic field modulated by the substance-specific oscillations. Investigations into applications of energetic medicine have shown that even such weak fields can provide desirable physiological effects. The device for outputting the homeopathic information can, therefore, include a conventional magnetic-field therapy or magnetic mat device.

The device can include sensors for measuring physiological parameters of the living body. It can include, therefore, a system for self-diagnosis in combination with the device for reproduction of homeopathic information and can be responsive, for example, to such physiological parameters as skin conductivity, heart or pulse frequency, and pulse or heart wave shape, an EEG or the like. Such test devices are known, for example, from the field of biofeedback.

A user can, for example, download from the internet, test substances in an MP3 format and can determine via the test device how the body reacts to such test substances. A form of self-service, individualized interactive practice of medicine is therefore possible via the internet. The test principle is dependent upon the observation that nonmatching substances tend to generate stress in the user and the stress can be picked up by biofeedback test devices. Positively acting substances have an opposite effect and an energy balance which is displayed in terms of other biofeedback parameters.

### BRIEF DESCRIPTION OF THE DRAWING

The above and other objects, features, and advantages will become more readily apparent from the following description, reference being made to the accompanying drawing in which:

FIG. 1 is a block diagram showing the principle of the invention; and

FIG. 2 is a block diagram describing the application of the homeopathic information.

### SPECIFIC DESCRIPTION

The invention depends upon the existence of a global computer information network which has been represented at 3 and which includes an internet site built with a data bank 2 which can be accessed from a location remote from the web site 1. The desired homeopathic information is stored in the data bank 2 in an MP3 form and can be transferred to the website via a browser system or the like. The information can be available in any 5 other data format which can store oscillation information with high quality. For practical reasons the data is stored utilizing the protocol for digital storage of music and preferably the MP3 format. The use of a high fidelity audio technique has been found to give good results. There is a significant amount of hardware and software available for supporting internet use and several of these utilize the MP3 format. Downloading of the homeopathic information available when the internet is possible by any internet user which is afforded access to the site. Any user can convert the stored information into individual substances with different homeopathic potentials (see U.S. Pat. No. 5,830,140), or complex mixtures of a variety of substances. The types of substances as to which homeopathic information is down-loaded depends upon the use and user and is practically without limit.

To apply the method and apparatus of the invention to substances for testing or therapy, the user can contact the internet site 1 via the internet 3 to access the data bank 2 and then downloads the desired “substance” in terms of its spectrum to the user terminal. The user terminal can basically comprise any apparatus which is compatible with the internet and can be, for example, an internet appliance which is specifically designed to communicate with the internet. It can, of course, be a general purpose apparatus as well. It is thus not essential that the terminal itself be equipped with the data format for reproducing the stored substance information. For example, it can be simply a terminal which stores the downloaded data and then can deliver downloaded data to a reproducing device.

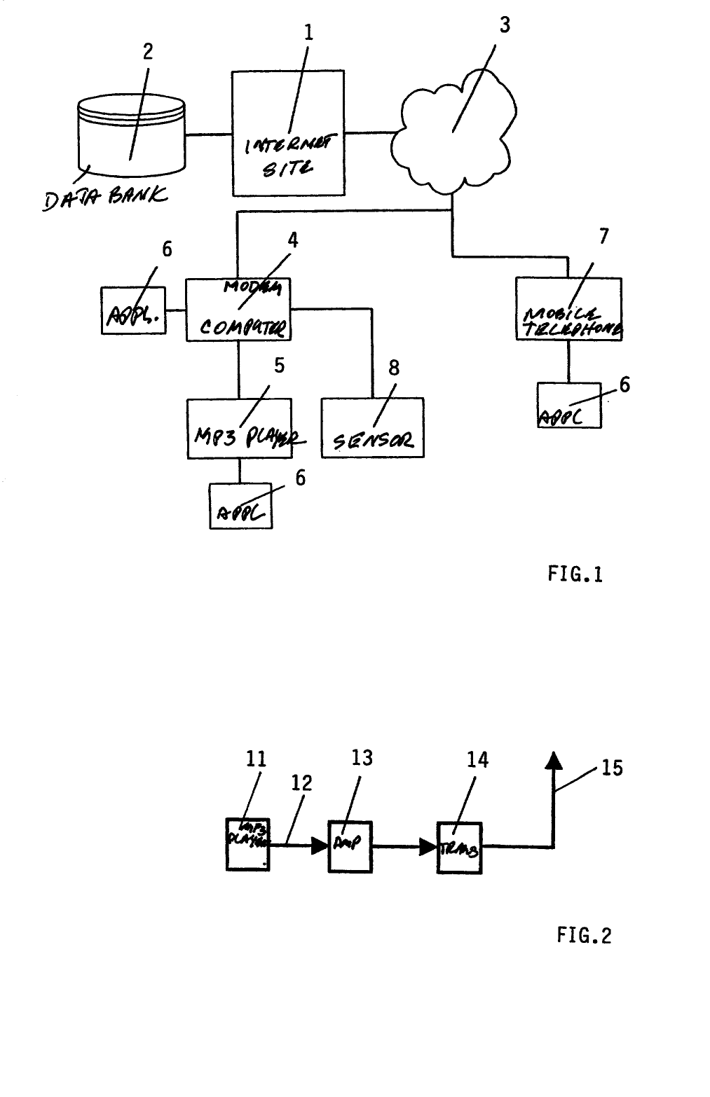

In FIG. 1 the terminal is a PC 4 which can be provided with MP3 capabilities or a mobile telephone 7 with such capabilities connected to the internet 3 by a wireless communication system. The computer 4 can have a telephone modem for communication to the web. From the PC, the downloaded data can be supplied to an MP3 player 5. The computer 4 can be equipped with an applicator 6, e.g. a D/A converter and a pair of electrodes which can be connected to the earphone jack of the player 5 or an audio output of the PC and can apply the electromagnetic waves directly to the individual or can be constructed to produce a homeopathic medicament or test substance. The device 6 can be constructed in accordance with the principle of AT 1358 U and as shown in FIG. 2. The mobile telephone likewise is provided with such a device 6.

A reproducing system can have the configuration shown in FIG. 2 herein, in which case the MP3 player 11, which produces the analog substance information from the digitally transmitted data can be connected, preferably via the earphone output 12 to an amplifier 13 which can be connected to a transmitter 14 provided with an antenna 15 radiating the electromagnetic field. This field contains the desired homeopathic information. Depending upon the use, the antenna 15 can have a variety of configurations. Preferably the unit shown in FIG. 2 can be a compact device supplied with electric current by batteries and fabricated as an integrated circuit or from integrated circuits. This allows mass production of applicator units, The applicator can impress the homeopathic information on carrier substances as described in AT 1358 U. A commercial testing device for physiological parameters is used at 8 and can be connected to the computer 4 so that physiological indications of the patient can be measured following administration of a treatment or during administration of a treatment or in response to administration of a medicament or test substance prepared in accordance with the invention and can assist in a determination as to whether a particular recipe prepared is effective or suitable for him or her. With electrodes the electromagnetic signal can be applied directly to the patient, preferably adhesive electrodes are used and these can be connected to the apparatus via special interface cables, e.g. shielded cables, preventing interference from external fields.

We claim:

1. A method of registering homeopathic information comprising the steps of:
(a) obtaining an analog electromagnetic spectrum representing homeopathic information;
(b) digitizing said analog electromagnetic spectrum to produce a digitalized spectrum containing said homeopathic information; and
(c) storing the digitalized spectrum on a data-storage medium with a data processor in a digital music compression data format for digital communication and reproduction of music.

2. The method defined in claim 1 wherein said data format is an MP3 format.

3. A method of using homeopathic information, comprising the steps of:
(a) storing homeopathic information in a form of a plurality of electromagnetic homeopathic spectra at a site;
(b) accessing said site and selecting at least one of the stored plurality of homeopathic spectra with a global computer information network from a location other than said site;
(c) at said location with a data processor recording in a data storage medium a selected homeopathic spectrum through said global computer information network;
(d)converting the selected homeopathic spectrum recorded in said data storage medium to an analog signal; and
(e)amplifying and homeopathically applying the analog signal.

4. The method defined in claim 3 wherein said at least one of the stored plurality of homeopathic spectra is selected by inputting through said global computer information network at least one medical symptom or physiological indication.

5. The method defined in claim 4 wherein a number of homeopathic spectra are selected, a sum of the selected spectra is formed and said sum is communicated to said data processor.

6. The method defined in claim 5 wherein for each spectrum or sum communicated to said data processor, dose information as to treatment duration, number of treatments and duration between treatments is communicated to the data processor.

7. The method defined in claim 6 wherein said dose information is determined by the medical symptom or physiological indication.

8. The method defined in claim 3 wherein said analog signal is applied to an electrode or antenna.

9. The method defined in claim 8 wherein the analog signal is homeopathically applied in step (e) to a carrier selected from a liquid, a salve base or globuli in a direct vicinity of the electrode or antenna for preparing a homeopathic medicament or test substance.

10. The method defined in claim 3 wherein the electromagnetic spectra are stored at said site by:
(a1) obtaining an analog electromagnetic spectrum representing homeopathic information for each of a number of medical symptoms and physiological indications;
(a2) digitizing each of said analog electromagnetic spectra to produce a respective digitalized spectrum containing the respective said homeopathic information; and
(a3) storing all of the digitalized spectra on a data-storage medium at said site in a digital music compression data format for digital communication and reproduction of music.

11. The method defined in claim 10 wherein said data format is an MP3 format.

12. An apparatus for reproducing homeopathic information in a form of electromagnetic oscillation, said apparatus comprising:
a data processor having a data storage medium in which homeopathic information is stored as digitalized spectra on a data-storage medium in a digital music compression data format for digital communication and reproduction of music;
a digital-to-analog converter for converting a homeopathic spectrum recorded in said data storage medium to an analog signal; and
a device for amplifying and homeopathically applying the analog signal to output corresponding electromagnetic oscillations.

13. The apparatus defined in claim 12 wherein said device is connected to an analog output of a component of said data processor for reproducing digitally recorded music.

14. The apparatus defined in claim 13 wherein said component is an MP3 player.

15. The apparatus defined in claim 13, further comprising means for connecting said data processor to a global computer information network by modem or wireless.

16. The apparatus defined in claim 15 wherein said global computer information network is the Internet.

17. The apparatus defined in claim 16 wherein said component is an internet compatible portable wireless telephone supporting a music reproduction data format.

18. The apparatus defined in claim 13 wherein said device includes a magnetic field therapy or magnetic mat unit.

19. The apparatus defined in claim 12 wherein said device is a unit generating a weak electromagnetic field modulated by substance specific oscillations corresponding to said electromagnetic oscillations.

20. An apparatus for reproducing homeopathic information in a form of electromagnetic oscillations, comprising:
a data processor connectable by modem or wirelessly to a global computer information network for downloading digitally recorded electromagnetic spectra carrying homeopathic information;
a data storage for said data processor for registering a digitally recorded electromagnetic spectra carrying homeopathic information downloaded from said network;
a digital-to-analog converter for converting a homeopathic spectrum recorded in said data storage an analog signal; and
a device for amplifying and homeopathically applying the analog signal to output corresponding electromagnetic oscillations.

21. The apparatus defined in claim 20 wherein said data processor is provided with a device for measuring physiological parameters of a living being.
